(19) United States
(12) Patent Application Publication
(10) Pub. No.: US 2005/0260497 A1
(43) Pub. Date: Nov. 24, 2005

(54) Energy storage device, energy storage device module, and electric car using the same

(76) Inventors: Yoshiaki Kumashiro, Mito (JP); Juichi Arai, Higashiibaraki (JP); Mituru Kobayasi, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/059,350

(22) Filed: Feb. 17, 2005

(30) Foreign Application Priority Data
May 19, 2004 (JP) 2004-148854

(51) Int. Cl. H01M 4/58; H01M 4/52; H01M 4/50; B60L 11/18

(52) U.S. Cl. 429/231.8; 429/223; 429/231.3; 429/224; 180/65.3; 429/188

(57) ABSTRACT

An energy storage device comprising a negative electrode plate having a negative electrode active material layer of a carbonaceous composite material formed on a negative electrode collector, a positive electrode plate having a positive electrode active material layer capable of inserting and releasing lithium ions and a non-faradic reaction layer capable of accumulating and releasing electric charges upon physical adsorption-desorption of ions on the surface layer of the positive electrode active material layer and an insulator layer for electrically insulating the positive electrode plate from the negative electrode plate, the insulator layer being capable of permeating only mobile ions. The carbonaceous composite material comprises particles of graphite and/or amorphous carbon and activated charcoal, and the particles of the graphite and/or amorphous carbon and particles of the activated charcoal are united.

### CLAIM OF PRIORITY

This application claims priority from Japanese application serial No. 2004-148854, filed on May 19, 2004, the content of which is hereby incorporated by reference into this application.

### FIELD OF THE INVENTION

The present invention relates to an energy storage device, an energy storage device module, and an electric car using the same. In the above, the electric car includes a hybrid car having an internal engine and the energy storage device.

### RELATED ART

In recent years, as power sources for electric cars, hybrid cars, electric tools, etc., higher input-output power sources than the conventional power sources are desired. Such the power sources should be able to quickly charge and discharge and to have a higher capacity than the conventional ones. The power source should be less dependable on the state of discharge of the batteries, and should be less dependable on temperatures; the power source should exhibit good input-output characteristics at low temperatures such as −20° C., −30° C., etc.

In order to satisfy the above requirements, improvements of lithium secondary batteries, metal hydride batteries, nickel-cadmium batteries, lead acid batteries, etc, whose reaction mechanism is mainly faradic have been made. There have been proposed combinations of electric double layer capacitors with the conventional batteries reaction mechanisms of the former are non-faradic and excellent in input-output characteristics for quick input-output power sources and excellent in performance at low temperatures. Further, in order to develop batteries with high energy density, high output performance and low temperature characteristics, there is disclosed in the patent document (Japanese patent laid-open 2002-260634) an energy storage device wherein activated charcoal used as a material for an electric double layer capacitor is used in the lithium secondary battery.

However, lithium secondary batteries are poor in charge-discharge characteristics at large current, particularly poor in input-output characteristics at low temperatures. Further, the electric double layer capacitor has a low energy density. When the activated charcoal used as the electric double layer capacitor is added to a positive electrode of the lithium secondary battery, it is difficult to increase an amount of the activated charcoal in the battery. Accordingly, the absolute value of the capacity of the capacitor should be low; while there is a slight improvement in short time output performance at low temperature, the characteristics of the battery are insufficient.

### SUMMARY OF THE INVENTION

The present invention aims at removing the above-mentioned problems and provides an energy storage device excellent in input-output characteristics at low temperatures.

The inventors of the present invention have discovered that an energy storage device which uses a carbonaceous material wherein particles of graphite and/or amorphous carbon are united with activated charcoal, particularly at least part of the particles of the graphite and/or amorphous carbon being covered with the activated charcoal is used as an active material, can solve the above-mentioned problems.

According to the present invention, a negative electrode plate having a negative electrode active material layer of a carbonaceous composite material comprising particles of graphite and/or amorphous carbon and of activated charcoal, the carbonaceous material being united; a positive electrode plate comprising a positive electrode active material capable of inserting and releasing lithium ions and a non-faradic reaction layer formed on the positive electrode active material layer, the non-faradic reaction layer being capable of storing and discharging electric charges upon ions are adsorbed and desorbed on the surface of the positive electrode active material layer, and an insulating layer sandwiched between the positive electrode plate and the negative electrode plate, for electrically insulating them and for permeating the mobile ions. The present invention provides an energy storage device module and a hybrid car using the energy storage device module.

In the present specification, the “faradic reaction” means a reaction that forms a layer where electric charges transfer through the electric double layer and through the interface of the electrode into the active material. This reaction is similar to that of primary batteries or secondary batteries. On the other hand, the “non-faradic reaction” means a reaction that forms a layer where transfer of electric charges does not occur, but accumulation and release of electric charges takes place upon ions are physically adsorbed and desorbed in the surface of the electrode. Therefore, the non-faradic reaction layer is a layer where the above-mentioned transfer of electric charges takes place. This reaction is similar to that of electric double layer capacitor. Accordingly, the non-faradic layer and the faradic layer can be distinguished by whether the layer brings about faradic reaction or non-faradic reaction.

The energy storage device according to the present invention has excellent input-output characteristics, particularly at low temperatures.

### BRIEF DESCRIPTION OF THE DRAWINGS

FIG. 1 is a cross sectional view of a coin type energy storage device according to the first embodiment.

FIG. 2 is a cross sectional view of a coin type energy storage device according to the second embodiment.

FIG. 3 is a cross sectional view of a coin type energy storage device according to the third embodiment.

FIG. 4 is a cross sectional view of a coin type energy storage device according to the fourth embodiment.

FIG. 5 is a cross sectional view of a coin type lithium secondary battery according to the fifth embodiment.

FIG. 6 is a graph showing V-I characteristics for calculating output characteristics of secondary batteries.

FIG. 7 is a partially broken, perspective view of an energy storage device module of the present invention.

FIG. 8 is a diagrammatic figure of a hybrid car using the energy storage device module of the present invention.

### DETAILED DESCRIPTION OF THE PREFERRED EMBODIMENTS

According to the present invention, an energy storage device is constituted by providing a negative electrode plate having a carbonaceous negative electrode active material layer formed on an electrode collector and a layer of a non-faradic reaction on a positive electrode of a lithium secondary battery, the non-faradic reaction layer being capable of accumulating and discharging electric charges upon adsorption-desorption of ions in the surface of an active material such as activated charcoal, which is used as a material for the electric double layer capacitor. As a result, a positive electrode plate can store and discharge electric energy. An insulating layer that permeates mainly mobile ions and electrically insulates the positive electrode plate and the negative electrode plate is disposed between the electrode plates.

Further, according to the present invention, an energy storage device is constituted by a negative electrode plate having the carbon composite negative electrode active material layer formed on the collector and a positive electrode plate having a positive electrode active material layer made of the activated charcoal formed on the collector as an electric double layer, the positive active material being a non-faradic reaction layer, which is able to accumulate and discharge electric charges upon adsorption and desorption of ions in the surface of the positive electrode active material. An insulating layer sandwiched between the positive electrode plate and the negative electrode plate electrically insulates the positive electrode and the negative electrode from each other.

Next, an example of a method of preparing the carbon composite material used in the energy storage device of the present invention will be explained in the following. However, the scope of the present invention should not be limited by the example.

The non-faradic reaction layer is preferably made of activated charcoal as a principal component, which accumulates and discharges electric charges upon physical adsorption-desorption of ions in the surface of the electrode active material. A preferable positive active material is a member selected from the group consisting of LiNiₓMn_{y}Co_{z}O₂ (x+y+z=1) and composite oxides of transition metals such as Co, Ni, Mn, etc.

A gel like electrolyte comprising a polymer and a liquid electrolyte can be sandwiched between the positive electrode plate and the negative electrode plate. As a source of mobile ions, in addition to Li salts or Li compounds, a quaternary onium cation salt represented by the following general formula may be added.

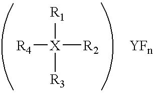

In the above-formula, R₁, R₂, R₃ and R₄ are the same or different, selected from H and alkyl groups having carbon atoms of 1 to 3, X is N or P, Y is B, P or As, and n is an integer of 4 or 6.

A plurality of the above mentioned energy storage devices and a control circuit for controlling the energy storage devices are connected in series, in parallel or in series-parallel to constitute an energy storage device module for the practical use. It is also possible to provide an electric car which has a motor driven by electric power supplied by the energy storage device module mounted on a chassis. A hybrid car having an internal engine and the energy storage device module is provided by the present invention.

According to the present invention, there is provided an energy storage device wherein a positive electrode plate having a positive electrode active material layer whose active material is carbon composite material comprising particles of graphite and/or amorphous carbon and the activated charcoal particles, the graphite and/or amorphous carbon particles and the activated charcoal being united, and a negative electrode plate having a positive electrode active material layer of a positive electrode active material formed on a positive collector wherein particles of graphite and/or amorphous carbon and activated charcoal are united.

Further, there is provided an energy storage device comprising a positive electrode plate having a positive electrode active material layer formed on a collector wherein at least part of the surface of particles of graphite and/or amorphous carbon is covered with activated charcoal to unite the materials, and a negative electrode plate having a negative electrode active material layer formed on a negative electrode collector wherein at least part of the surface of particles of graphite and/or amorphous carbon is covered with particles of the activated charcoal to unite the materials.

The particles of the graphite and/or amorphous carbon should preferably have an average particle size of 20 μm or less from the view point of a cycle life of the energy storage device. More preferably, the average particle size should be 1 to 20 μm. Most preferably, the average particle size should be 5 to 10 μm.

The (002) face distance of graphite measured by an X-ray diffraction method is 0.3350 nm or more to less than 0.3370 nm. The amorphous carbon is defined as one having the (002) face distance being 0.3370 nm or less. A BET specific surface area of the particles should be 20 m²/g or less, more preferably 0.5 to 5 m²/g.

The above-mentioned particles should be united with the activated charcoal. There are particles of graphite and/or amorphous carbon whose surface is completely covered with the activated charcoal and whose surface is partially covered with the activated charcoal. Although the particles, which are completely covered with the charcoal, are preferable, particles, which are covered partially with the charcoal, are acceptable.

There are one or more of particles of the graphite and/or amorphous carbon buried in the particles of the activated charcoal. Even if there are many particles of the charcoal in the particles of graphite and/or amorphous carbon particles, there may be no problem if the graphite and/or amorphous particles are buried in the charcoal particles.

The activated charcoal should have an average particle size of 0.5 to 5 μm and a specific surface area of 1000 to 3000 m²/g. The charcoal has fine pores called micro pores of 2 nm or less in diameter, fine pores called meso pores of 2 to 50 nm in diameter and fine pores called macro pores of 50 nm or more in diameter. It is preferable to use activated charcoal having meso pores of 2 to 5 nm in diameter.

The particles of the graphite and/or amorphous carbon before mechanical pressing are acceptable even if they do not have the above-mentioned particle structure. As the pressing is repeated, the particle size becomes smaller to be a desired particle size. In order to mechanically press the activated charcoal to the graphite and/or amorphous carbon, the particles should be closely contacted with each other. Therefore, a pressing apparatus is selected for that purpose.

As the pressing apparatus, there are a planetary type ball mill apparatus, which is capable of pressing by collision between balls and a wall of the container or collision between balls to impart mechanical pressing force to the particles and an apparatus, which is capable of mechanical pressing the particles between a pressing spatula and the container walls.

By the use of the apparatus mentioned-above, particles of graphite and/or amorphous carbon are buried in the activated charcoal particles to unite them. After repetition of pressing, the particles may be heat-treated at 200 to 1000° C. An atmosphere for heat treatment should be such that the graphite and/or amorphous carbon and activated charcoal do not burn, such as inert gases, nitrogen gas or vacuum.

The carbon composite materials are not limited to the product by a mechanical pressing method. For example, particles of graphite and/or amorphous carbon and activated charcoal powders are mixed and stirred with a solvent such as tetrahydrofuran. The mixture is refluxed, and dried. Then, the mixture was heated at 600 to 1000° C. to obtain a desired powder. The atmosphere for the heat treatment is inert gases, nitrogen gas or vacuum.

A particle size of the resulting carbonaceous material should preferably be 1 to 50 μm, more preferably 5 to 20 μm. A BET specific surface area of the carbonaceous material should preferably be 1000 m²/g or less, more preferably, 50 to 500 m²/g. E pore size distribution should preferably be 20 to 50 nm.

An X-ray diffraction particle size measurement apparatus can measure an average particle size. The BET specific surface area and the pore size distribution are measured by an N₂ adsorption isotherm curve. The state of unified graphite and/or amorphous carbon and activated charcoal particles is observed with an electron microscope photograph.

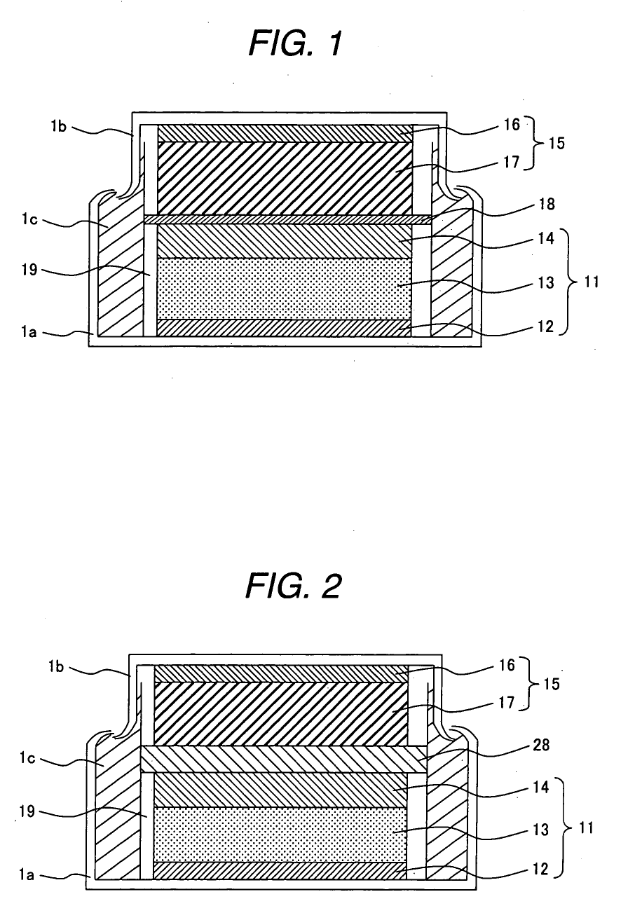

Next, one embodiment of the energy storage device according to the present invention will be explained by reference to FIG. 1. FIG. 1 shows a cross sectional view of a coin type energy storage device of the first embodiment. Numeral 11 denotes a positive electrode plate, which is prepared by coating a positive electrode active material layer 13 of a positive electrode active material on a positive collector 12, and coating a non-faradic reaction layer 14 is on the layer 13.

Numeral 15 denotes a negative electrode plate, which is prepared by coating a negative electrode active material layer 17 of a negative electrode material on a negative electrode collector 16.

An insulating layer (spacer) 18 is sandwiched between the positive electrode plate 11 and negative electrode 15 to electrically insulate the electrode plates each other. The insulator permeates only mobile ions. The above members are encased in a case and the case is filled with a liquid electrolyte thereby to manufacture an energy storage device. A positive can 1a and a negative can 1b are sealed and electrically insulated with a gasket 1c. By firmly holding the liquid electrolyte in the insulating layer and the electrodes, the transfer of ions between the positive electrode plate and the negative electrode plate is realized.

In the following, the same numerals in FIGS. 2 to 8 as in FIG. 1 mean the same as in FIG. 1, unless otherwise specified.

It is possible to manufacture the energy storage devices other than the coin type. In the case of columnar type energy storage devices, electrodes are prepared by winding a set of the positive electrode plate, the insulating layer and the negative electrode plate. When the set of electrodes and the insulating layer is wound in a double axis, an energy storage device of a long circle shape in a cross sectional area is obtained.

In the case of a rectangular shape, the electrodes are cut into stripes. Then, the stripes of the electrodes are wound alternately, and the insulating layer is inserted between the electrodes. The present invention is not limited to the above examples.

A method of manufacturing a positive electrode plate and a negative electrode plate will be explained in the following.

The positive electrode active material capable of inserting and releasing lithium ions is an oxide containing lithium. Examples of the material are composite oxides represented by LiNiₓMn_{y}Co_{z}O₂ (x+y+z=1) such as Li_{1/3}Ni_{1/3}Co_{1/3}O₂, LiMn_{0.4}Ni_{0.4}Co_{0.2}O₂, etc. and composite oxides of Li and one or more of transition metals such as Co, Ni, Mn. Since the positive electrode active material is of generally high resistance, the positive active material is mixed with a conductive material such as carbon powder to improve conductivity of the positive electrode active material. This material may be conduction assistant. Because the positive active material and the conductive material are powders, a binder is added thereto. The mixture is coated on a collector and shaped in a desired shape.

The conductive material may be natural graphite, synthetic graphite, cokes, carbon blacks, amorphous carbon, etc. The positive electrode material should be hard to dissolve in the liquid electrolyte. An example of the positive electrode is aluminum foil. A positive electrode slurry comprising the positive electrode active material, the conductive material, the binder and an organic solvent is coated on the positive electrode collector by a doctor blade method, wherein a blade is used to coat the slurry. The coated member is heated to remove the solvent. The resulting electrode material is molded by press molding.

Then, a non-faradic reaction layer is coated or added on the positive electrode material. As the non-faradic reaction layer, there are substances having a large specific surface area and being free from oxidation-reduction reaction over a wide range of voltages, such as carbonaceous materials including activated charcoal, carbon black, carbon nano-tubes, etc. From the viewpoints of the specific surface area and a material cost, activated charcoal is preferable.

More preferably, the activated charcoal should have an average particle size of 1 to 100 μm, a BET specific surface area of 1000 to 3000 m²/g, fine pores called micro-pores of 2 nm or less in diameter, meso pores of 2 to 50 nm in diameter, and macro pores of 50 nm or more in diameter. Particularly, the activated charcoal having meso pores of 2 to 50 nm in diameter is useful. The conductive material and binder mixture is coated on the positive electrode active material layer to form the non-faradic reaction layer.

The resulting positive electrode active material layer and the non-faradic reaction layer are heated to remove the solvent. Then the product is pressure-molded with press-roles so that the layers are intimately bonded to each other to produce a positive electrode material. The binder includes polytetrafluoroethylene, polyvinylidene fluoride, fluorine containing resins such as fluorine rubber, thermoplastic resins such as polypropylene, polyethylene, etc, thermosetting resins such as polyvinyl alcohol, styrene-butadiene resins, carboxymethyl cellulose, etc.

The positive electrode plate 31 can be manufactured in the following manner. As non-faradic reaction layer 33, the activated charcoal, the conductive assisting agent and polytetrafluoroethylene are mixed to make sheet by role-press molding. The resulting non-faradic reaction layer 33 and the positive electrode collector 32 are bonded by spraying or with a conductive adhesive to manufacture the positive electrode plate 31.

Further, in place of the positive electrode shown in FIG. 1, the positive electrode active material 43 comprising carbonaceous composite material according to the present invention is coated on the positive electrode collector 42, as shown in FIG. 4.

The negative electrode plate is obtained by coating the carbonaceous material as the negative electrode active material on the collector. Since the negative electrode active material is powder, a binder is mixed with it and the mixture is coated on a collector and dried. The negative electrode active material should be such substance as copper that does not alloy with lithium. A negative electrode slurry containing the negative electrode active material, the binder and the solvent is coated on the collector by a doctor blade method, and heated to remove the organic solvent. The resulting negative electrode active layer is pressure-molded by a roll-press method to obtain the negative electrode material.

The insulating layer electrically insulates the positive electrode and the negative electrode and penetrates only mobile ions; the insulating layer is made of polymeric porous film or sheet made of polyethylene, polypropylene, polyethylene tetra-fluoride, etc.

Liquid electrolytes include organic solvents such as ethylene carbonate (EC), propylene carbonate (PC), dimethyl carbonate (DMC), diethyl carbonate (DEC), methyl ethyl carbonate (MEC). The electrolytes further contain a lithium salt electrolyte such as lithium phosphate hexafluoride (LiPF₆), lithium borate tetra-fluoride (LiBF₄) in an amount of 0.5 to 2 M. A salt containing quaternary onium cations such as tetra-alkyl phosphonium fluoroborate, tetra-alkyl ammonium tetra-fluoroborate, etc may be added to the electrolytes.

As shown in FIG. 2, a gel like electrolyte 28 may be disposed between the positive electrode 11 and the negative electrode 15 to constitute the energy storage device of the present invention. The gel like electrolyte includes polyethylene oxide (PEO), polymethyl methacrylate (PMMA), polyacrylonitrile (PAN), polyvinylidene fluoride (PVdF), polyvinylidene-hexafluoro propylene copolymer (PVdF-HFF), etc., which is used in the swollen state with the liquid electrolyte.

In place of the positive electrode plate 11, the energy storage device can be constituted by using a positive electrode plate 31 formed by coating the non-faradic reaction layer 33 on the positive electrode collector 32. As the non-faradic layer 33, there are carbonaceous materials that have a large specific surface area and do not bring about oxidation-reduction reaction over a wide range of voltages, such as activate charcoal, carbon black, carbon nano-tubes, etc. From the view points of the specific surface area and the material cost, the activated charcoal is preferable.

More preferably, the activated charcoal should have an average particle size of 1 to 100 nm and a BET specific surface area of 1000 to 3000 m²/g. The activated charcoal should preferably have micro-pores of 2 nm in diameter, meso-pores of 2 to 50 nm in diameter and macro-pores of 50 nm in diameter. Particularly, the activated charcoal should preferably have meso-pores of 2 to 5 nm in diameter.

A slurry mixture of the activated charcoal and the binder is coated on the positive electrode collector 32, and heated to dry it. The coating is molded by press-roles to intimately bond the collector and the non-faradic reaction layer.

An energy storage device module of the present invention can be constituted in the following manner. A plurality of the energy storage devices is connected in series in accordance with a desired voltage. A voltage detector means for detecting a voltage of each of the energy storage devices and a control circuit for controlling charge-discharge current of each of the energy storage devices are disposed to the module. Further, means for giving instruction to the control circuit is provided. Electric communications are carried out among the components.

When a detected voltage by the detection means is lower than a predetermined charging voltage, current is supplied to the energy storage devices to charge them.

At the time of charging, when the voltage of the energy storage devices reaches the predetermined charging voltage, the charging current is cut off in accordance with signals from the control circuit so as to prevent over-charge of the devices.

At the time of discharging, when the voltage of each of the energy storage devices reaches the predetermined voltage, discharging is terminated to prevent over-discharge.

An accuracy of voltage detection should preferably be 0.1 V or less in terms of voltage resolution, more preferably, 0.02 V or less. The precise detection of voltage of each of the energy storage devices and precise control of the energy devices to prevent over-voltage and over-discharge will realize the energy storage device module.

### EMBODIMENTS

In the following the embodiments of the energy storage device according to the present invention will be explained in detail. The scope of the present invention will not be limited by these embodiments.

### Embodiment 1

Amorphous carbon having an average particle size of 12 μm and a BET specific surface area of 3.3 m²/g and activated charcoal having a BET specific surface area of 1000 m²/g were mixed at a mixing ratio of 50:50, followed by ball mill grinding treatment of the mixture with a planetary ball mill apparatus for 24 hours.

A ball mill container and balls were made of stainless steel, and the treatment was conducted in argon atmosphere. Then, the ground mixture was heat treated at 800° C. in argon atmosphere for one hour. Observation of the sectional face of the particles revealed that the amorphous carbon was buried in the activated charcoal. The BET specific surface area of the resulting composite carbon material for the negative active material was 463 m²/g.

A negative electrode was prepared using the resulting composite carbon material. The composite carbon material and carbon black having an average particle size of 0.04.μm and a specific surface area of 40 m²/g were mechanically mixed at a mixing ratio of 95:5 by weight. A binder solution was prepared by dissolving 8% by weight of polyvinylidene fluoride in N-methyl pyrrolidone. The mixture of the composite carbon material and carbon black was thoroughly mixed with the binder solution so that the weight ratio of the carbonaceous material to polyvinylidene fluoride is 90 to 10. The mixture was roll-pressed to form an electrode material. The electrode material was punched into a disc having a diameter of 16 mm.

### Embodiment 2

A carbonaceous composite material was prepared in the same manner as in Embodiment 1, except that graphite powder having an average particle size of 15 μm and a BET specific surface area of 2 m²/g was used. The BET specific surface area of the resulting composite material was 392 m²/g. Using the negative active material, a negative electrode was prepared.

### COMPARISON EXAMPLE 1

A carbonaceous composite material was prepared in the same manner as in Embodiment 1, except that amorphous carbon powder having an average particle size of 12 μm and a BET specific surface area of 3.3 m²/g was used. Using the negative active material, a negative electrode with a disc having a diameter of 16 mm was prepared.

### COMPARISON EXAMPLE 2

A carbonaceous composite material was prepared in the same manner as in Comparison example 1, except that graphite powder having an average particle size of 15 μm and a BET specific surface area of 2 m²/g was used. Using the negative active material, a negative electrode with a disc having a diameter of 16 mm was prepared.

### COMPARISON EXAMPLE 3

A carbonaceous composite material was prepared in the same manner as in Embodiment 1. except that graphite powder having an average particle size of 5 μm and a BET specific surface area of 1000 m²/g was used. Using the negative active material, a negative electrode with a disc having a diameter of 16 mm was prepared.

The negative electrodes obtained in Embodiments 1, 2 Comparison examples 1 to 3 and a lithium metal counter electrode were assembled via a polyethylene porous film having a thickness of 40 μm to constitute test cells. A mixed solvent consisting of ethylene carbonate and diethyl carbonate at a volume ratio of 1:2 containing 1 mol/dm³ of LiPF6 was used.

A charge current density was set to 0.5 mA/cm², and an upper limit voltage and lower limit voltage of discharge were 1.5 V and 0.005 V, respectively. Charging was conducted by a CCCV method for 4 hours. Discharging was conducted under conditions cut above 20 mA/cm² and 1.5 V.

In Table 1, there are shown initial charge-discharge capacity ratios and discharge capacity ratios of the electrodes at 20 mA/cm² of Embodiments 1, 2 and Comparison examples 1-3 and discharge capacities. The values are ratios of the values to that of Embodiment 1.

Although the initial charge-discharge efficiency of embodiments 1, 2 is inferior to that of comparative examples 1, 2, a discharge capacity of a discharge at 20 mA/cm² was drastically improved; it was confirmed that the output characteristics were improved by using the carbonaceous composite material.

TABLE 1

| | Initial capacity | Discharge capacity |
|---|---|---|
| | ratio | at 20 mA/cm² |
| Embodiment 1 | 51 | 1 |
| Embodiment 2 | 57 | 0.93 |
| Comparison example 1 | 89 | 0.21 |
| Comparison example 2 | 93 | 0.18 |
| Comparison example 3 | 25 | 0.07 |

### Embodiment 3

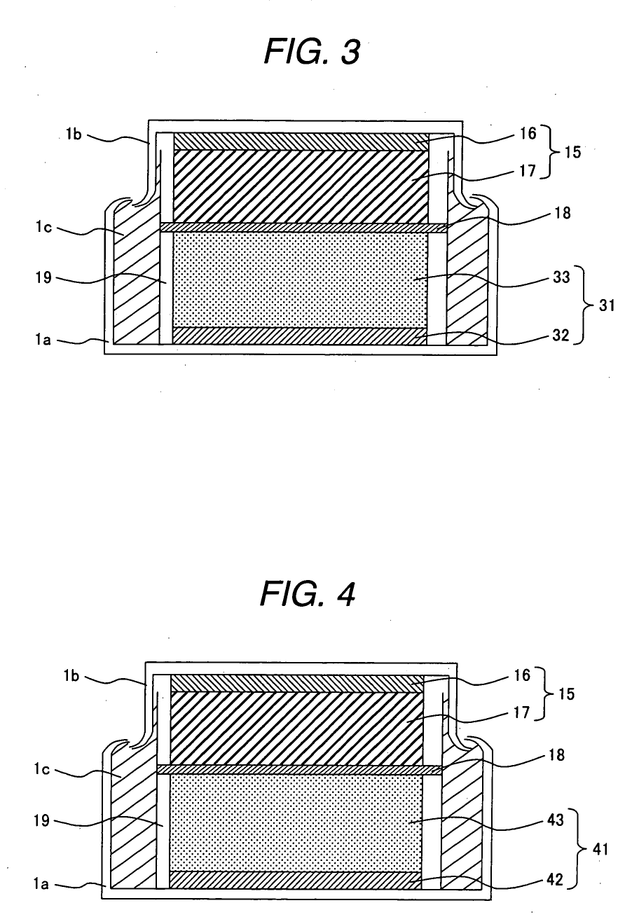

A coin type energy storage device having a structure shown in FIG. 3 was prepared.

A positive active material layer 33 was prepared in the following manner. A positive active material was LiCo_{1/3}Ni_{1/3}Mn_{1/3}O₂ having an average particle size of 10 μm and a conductive material was a mixture of graphite like carbon having an average particle size of 3 μm and a specific surface area of 13 m²/g and carbon black having an average particle size of 0.04 μm and a specific surface area of 40 m²/g. A binder was a solution of N-methyl pyrrolidone containing 8% by weight of polyvinylidene fluoride.

The positive active material, the conductive material and the binder were thoroughly mixed at a mixing ratio of 85:10:5 to prepare a positive electrode slurry. The positive electrode slurry was coated on one face of a positive collector 32 made of aluminum foil having a thickness of 20 μm and dried. The coated member was role-pressed to prepare an electrode material. The electrode material was punched into a disc having a diameter of 16 mm to obtain a positive electrode 31.

Next, a negative electrode active material layer 17 was prepared in the following manner.

A negative electrode material was amorphous carbon (d₀₀₂=0.360 nm) having an average particle size of 12 μm and a BET specific surface area of 3.3 m²/g and carbon black having an average particle size of 0.04 μm and a BET specific surface area of 40 m²/g was mixed at a mixing ratio of 95:5. A binder was an N-methyl pyrrolidone solution of 8% by weight of polyvinylidene fluoride. The carbonaceous material consisting of amorphous carbon and carbon black and the binder were thoroughly mixed at a mixing ratio of 90:10. The mixture was coated on one face of a negative electrode collector 16 made of copper foil having a thickness of 10 μm and dried. The coated member was role-pressed to prepare an electrode material. The electrode material was punched into a disc having a diameter of 16 mm to obtain a negative electrode.

A porous polyethylene separator 18 having a thickness of 40 μm was sandwiched between the negative electrode and the positive electrode to assemble a test cell. A mixed electrolyte consisting of ethylene carbonate and diethyl carbonate (volume ratio of 1:2) containing 1 mol/dm³ of LiPF₆ was filled in the cell. A positive can 1a and a negative cam 1b were sealed and electrically insulated from each other.

### COMPARISON EXAMPLE 4

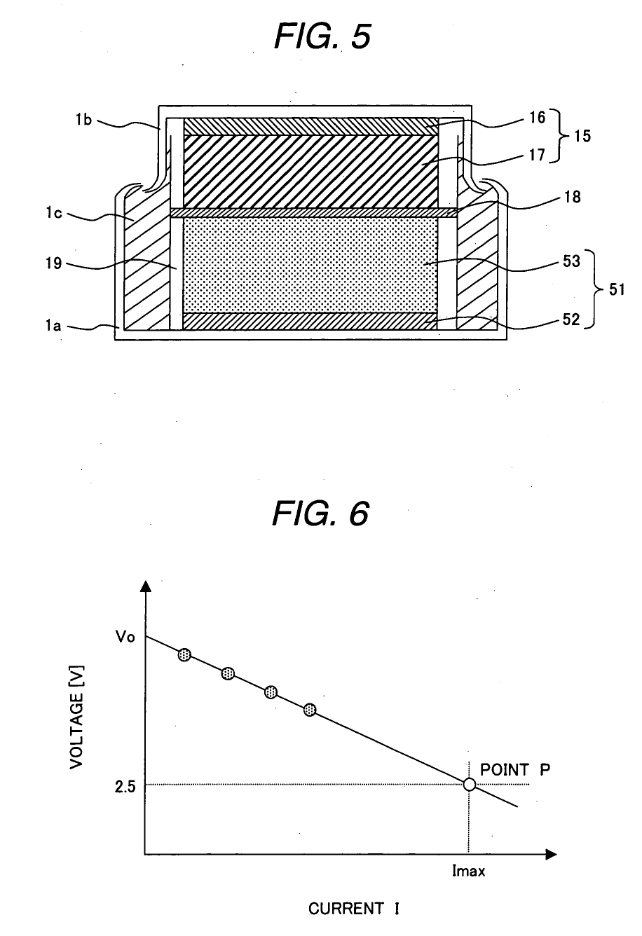

A coin type lithium secondary battery having a structure shown in FIG. 5 was prepared.

A positive electrode active material layer 53 was prepared in the following manner.

A positive electro was LiCo_{1/3}Ni_{1/3}Mn_{1/3}O₂ having an average particle size of 10 μm and a conductive material was a mixture of graphite like carbon having an average particle size of 3 μm and a specific surface area of 13 m²/g and carbon black having an average particle size of 0.04 μm and a specific surface area of 40 m²/g at a mixing ratio of 4:1. A binder was a solution of N-methyl pyrrolidone containing 8% by weight of polyvinylidene fluoride.

The positive electrode active material, the conductive material and the binder were thoroughly mixed at a mixing ratio of 85:10:5 to prepare a positive electrode slurry. The positive electrode slurry was coated on one face of a positive collector 52 made of aluminum foil having a thickness of 20 μm and dried. The coated member was role-pressed to prepare an electrode material. The electrode material was punched into a disc having a diameter of 16 mm to obtain a positive electrode 51.

Next, a negative electrode active material layer 56 was prepared in the following manner.

A negative electrode material was amorphous carbon (d002=0.360 nm) having an average particle size of 12 μm and a BET specific surface area of 3.3 m²/g and carbon black having an average particle size of 0.04 μm and a BET specific surface area of 40 m²/g was mixed at a mixing ratio of 95:5. A binder was an N-methyl pyrrolidone solution containing 8% by weight of polyvinylidene fluoride. The carbonaceous material consisting of amorphous carbon and carbon black and the binder were thoroughly mixed at a mixing ratio of 90:10. The mixture was coated on one face of a negative electrode collector 55 made of copper foil having a thickness of 10 μm and dried. The coated member was role-pressed to prepare an electrode material. The electrode material was punched into a disc having a diameter of 16 mm to obtain a negative electrode 54.

A porous polyethylene separator 18 having a thickness of 40 μm was sandwiched between the negative electrode and the positive electrode to assemble a test cell. A mixed electrolyte solution consisting of ethylene carbonate and diethyl carbonate (volume ratio=1:2) containing 1 mol/dm³ of LiPF₆ was filled in the cell. A positive can 19 and a negative can 1b were sealed and electrically insulated by a gasket 1c from each other.

### COMPARISON EXAMPLE 5

A coin type lithium secondary battery was prepared in the same manner as in comparison example 1, except that graphite powder having an average particle size of 15 μm and a BET specific surface area of 2 m²/g was used.

### COMPARISON EXAMPLE 6

An energy storage device having a structure shown in FIG. 1 was prepared.

A positive electrode material layer 13 was prepared in the following manner.

A positive electrode active material was LiCo_{1/3}Ni_{1/3}Mn_{1/3}O₂ having an average particle size of 10 μm and carbon black having an average particle size of 0.04 μm. A conductive material was a mixture of graphite powder having an average particle size of 3 μm and a specific surface area of 13 m²/g and carbon black having an average particle of 0.04 μm and a specific surface area of 40 m²/g at a mixing ratio of 4 to 1.

A binder was an N-methyl pyrrolidone solution containing 8% by weight of polyvinylidene fluoride. The positive electrode active material, the conductive material and the binder was thoroughly mixed at a mixing ratio of 85:10:5 to prepare a positive electrode slurry.

The slurry was coated on one face of a positive electrode collector 12 made of aluminum foil having a thickness of 20 μm and dried. The resulting coating member was role-pressed.

An activated charcoal layer 14 was formed on the positive electrode active material layer 13 in the following manner.

A mixture consisting of activated charcoal having a specific surface area of 2000 m²/g and carbon black having an average particle size of 0.04 μm and a specific surface area of 40 m²/g at a weight mixing ratio of 8:1 was mixed with a binder solution containing polyvinylidene fluoride dissolved in N-methyl pyrrolidone at a mixing ratio of the activated charcoal: carbon black: polyvinylidene fluoride=80:10:10.

The mixture was coated on one face of the positive electrode collector 12 and dried. The coating member was role-pressed to manufacture an electrode material. The electrode material was punched into an electrode having a diameter of 16 mm to produce a negative electrode 15.

The negative electrode plate 15 was prepared by coating the slurry on the negative electrode collector 16, pressed and punched into a disc having a diameter of 16 mm as in comparative example 1 to manufacture the negative electrode 15.

A porous polyethylene film 18 having a thickness of 40 μm was sandwiched between the positive electrode and the negative electrode to constitute a test cell. A mixed electrolyte 19 consisting of ethylene carbonate and diethyl carbonate at a volume ratio of 1:2, which contains 1 mol/dm³ of Li PF₆ was filled in the cell. The positive can 1a and the negative can 1b were sealed with a gasket 1c and electrically insulated from each other.

### COMPARISON EXAMPLE 7

A coin type energy storage device was assembled in accordance with the manner in comparison example 6, except that the negative electrode of comparison example 5 was used.

### Embodiment 4

A coin type energy storage device was assembled in the manner of comparison 6, except that the carbonaceous material was used as a negative electrode active material of embodiment 1.

Using the coin type energy storage devices of embodiments 3, 4, comparison examples 6, 7 and the lithium secondary batteries of comparison examples 4, 5, output characteristics at 25° C. and −30° C. were evaluated in accordance with the following method.

(Method of Evaluation of Output Characteristics)

The energy storage devices and the lithium secondary batteries were charged and discharged t 25° C. under the following conditions.

At first, after the devices and batteries were charged at a constant current of 0.5 mA/cm² until a voltage becomes 4.2 V, a constant current-constant voltage charge at 4.2 V was conducted for three hours. After completion of charge, a standstill for 30 minutes was conducted. Then, discharge at a constant current of 0.25 mA/cm² was conducted until the discharge termination voltage of 2.7 V. The above-mentioned charge-discharge was repeated 5 times.

Further, a constant current charge at 0.5 mA/cm², and a constant current-constant voltage charge at 4.2 V was conducted for three hours. The state for charging until 4.2 V is defined as DOD (Depth of Discharge)=0%. Thereafter, capacity equivalent to DOD=50% was discharged at a constant current of 0.25 mA/cm². DOD is defined as a rate (%) of discharge capacity to a rated capacity of a battery. The rated capacity is the discharge capacity in the range of from 4.2 V to 2.7 V; the discharge capacity rate at 4.2 V is 0% and the discharge capacity sate at 2.7 V is 100%.

Further, after a standstill of 30 minutes, short time discharges at 2.5 mA/cm², 5 mA/cm², 10 mA/cm², 15 mA/cm² and 20 mA/cm² were conducted, wherein the discharge time was 10 seconds and there was a standstill for 10 minutes between the discharges. Then, charge at 0.25 mA/cm² was conducted after the standstill so as to charge a capacity equivalent to discharged capacity at each discharge. For example, when discharge for 10 seconds at 2.5 mA/cm² is conducted, charge at 0.25 mA/cm² for 100 is conducted for 100 seconds. After the charge, a standstill was conducted for 30 minutes to stabilize the voltage. The next test was conducted after the voltage stabilized.

A voltage at the time of 5 seconds after start of discharge was read out from a charge-discharge curve obtained in the charge-discharge test for 10 seconds. The voltage was plotted to obtain a V-I curve shown in FIG. 6. Then, a crossing point P with abscissa of 2.5 V was exploited by the least squares method. The output density is calculated by (current value Imax at exploited crossing point P)×(starting voltage V0 of each of the charge-discharges)/(weight of the positive and negative active materials).

Measurements at −30° C. were conducted under the following conditions. After the energy storage devices and lithium secondary batteries were charged at a constant current of 0.5 mA/cm² at 25° C. until the voltage reaches 4.2 V, a constant current-voltage charge at 4.1 V was conducted for three hours. After completion of charging, a standstill for 30 minutes was conducted. Then, discharge was conducted at a constant current of 0.25 mA/cm² until DOD=50%. The measurement temperature at this state was changed to −30° C. After a lapse of 5 hours, short time discharge for about 10 seconds at 0.05 mA/cm², 1.5 mA/cm² and 3.0 mA/cm² were conducted to investigate output characteristics. The output characteristics were calculated in the above-mentioned manner at 25° C.

The results are shown in Table 2 as relative values at 25° C. wherein the output in comparative example 4 at DOD=0% is 1. The energy storage devices of embodiments 3, 4 exhibited higher output than the lithium secondary batteries and energy storage devices of comparative examples 4 to 7.

Further, the results at −30° C. are shown in Table 2 wherein the outputs are shown as relative values with respect to the output of comparison example 4 is defined as 1. The devices of embodiments 3, 4 exhibited higher output than the devices of comparison examples 4 to 7. Accordingly, output characteristics at low temperatures could be improved remarkably.

TABLE 2

Output ratio

| | 25° C. | −30° C. |
|---|---|---|
| Embodiment 3 | 1.41 | 2.41 |
| Embodiment 4 | 1.06 | 1.83 |
| Comparison example 4 | 1 | 1 |
| Comparison example 5 | 0.793 | 0.72 |
| Comparison example 6 | 1.03 | 1.23 |
| Comparison example 7 | 0.82 | 1.03 |

From the above facts, it has been revealed that the energy storage device of the present invention exhibits improved output characteristics particularly at low temperatures.

### Embodiment 5

A coin type energy storage device was prepared in the same manner as in comparison example 6, except that the carbonaceous material of embodiment 2 was used as the negative electrode active material.

### Embodiment 6

In embodiment 3, a coin type energy storage device was prepared using LiMn_{0.4} Ni_{0.4} Co_{0.2} O₂ having an average particle assize of 10 μm as a positive electrode material of a positive electrode material layer.

At first, the positive electrode active material layer was prepared. A conductive material was a mixture of graphite like carbon having an average particle size of 3 μm and a specific surface area of 13 m²/g and carbon black having an average particle size of 0.04 μm and a specific surface area of 40 m²/g was prepared at a mixing ratio of 4:1.

A binder was an N-methyl pyrrolidone solution containing 8% by weight of polyvinylidene fluoride. The positive electrode active material, the conductive material and the binder were thoroughly mixed at a mixing ratio of 85:10:5 to obtain a positive electrode slurry.

The positive electrode slurry was coated on one face of a positive electrode collector made of aluminum foil having a thickness of 20 μm and dried.

Further, an activated charcoal layer was formed on the positive electrode active material layer in the following manner.

A mixture of activated charcoal having a specific surface area of 2000 m²/g and carbon black having an average particle size of 0.04 μm and a specific surface area of 40 m²/g was prepared at a mixing ratio of 4:1.

A binder was an N-methyl solution containing 8% by weight of polyvinylidene fluoride.

The positive active material, the conductive material and the binder were mixed at a mixing ratio of 85:10:5 to produce a positive electrode slurry.

The positive electrode slurry was coated on one face of a positive electrode collector made of aluminum foil having a thickness of 20 μm and dried. The resulting member was role-pressed. An activated charcoal layer was formed on the positive electrode active material layer in the following manner.

A mixture of activated charcoal having a specific surface area of 2000 m²/g and carbon black having an average particle size of 0.04 μm and a specific surface area of 40 m²/g was prepared at a mixing ratio of 8:1. A binder was an N-methyl pyrrolidone solution containing 8% of polyvinylidene fluoride.

The activated charcoal, carbon black and polyvinylidene fluoride were thoroughly mixed at a mixing ratio of 80:10:10 to produce a positive electrode slurry.

The resulting slurry was coated on the positive electrode active material layer and dried. The coated member was role-pressed to make an electrode material. The electrode material was punched into a disc having a diameter of 16 mm. A coin type energy storage device was prepared according to embodiment 3, except that the above electrode was used.

### Embodiment 7

As a positive electrode material in embodiment 3, LiNi_{0.4} 0.8Co_{0.15}Al_{0.05}O₂ having an average particle size of 6 μm was used to make a coin type energy storage device.

At first, a positive electrode active material was prepared. A conductive material was a mixture of graphite like carbon having an average particle size of 3 μm and a specific surface area of 13 m²/g and carbon black having an average particle size of 0.04 μm and a specific surface area of 40 m²/g was prepared at a mixing ratio of 4:1. As a binder, an N-methyl pyrrolidone solution containing 8% by weight of polyvinylidene fluoride was used.

The positive electrode active material, the conductive material and the binder were thoroughly mixed at a mixing ratio of 85:10:5 to make a positive electrode slurry. The slurry was coated on one face of a positive electrode collector made of aluminum foil having a thickness of 20 μm and dried. The coated member was role-pressed.

An activated charcoal layer was formed on the positive electrode active material layer in the following manner.

A mixture of activated charcoal having a specific surface area of 2000 m²/g and carbon black having an average particle size of 0.04 μm and a specific surface area of 40 m²/g was prepared at a mixing ratio of 8:1. As a binder, an N-methyl pyrrolidone containing 8% by weight of polyvinylidene fluoride was used.

The activated charcoal, carbon black and polyvinylidene fluoride were thoroughly mixed at a mixing ratio of 80:10:10. The resulting slurry was coated on the positive electrode active material layer and dried. The resulting member was role-pressed to produce an electrode material. The electrode material was punched into a disc having a diameter of 16 mm. Using the electrode, a coin type energy storage device was prepared in the same way as in embodiment 3.

### Embodiment 8

In the coin type energy storage device of embodiment 3, an electrolyte consisting of ethylene carbonate and diethyl carbonate at a mixing volume ratio of 1:2 containing 1 mol/dm3 of LiPF6 and 0.05 mol/dm³ of (C₂H₅)NBF₄ was filled in the cell in place of the mixed electrolyte containing 1 mol/dm³ of LiPF6.

### Embodiment 9

A coin type energy storage device having a structure shown in FIG. 3 was prepared.

A positive electrode plate 31, which has a non-faradic reaction layer 33 on a positive electrode collector 32 was prepared in the following manner.

A mixture of activated charcoal having a specific surface area of 2000 m²/g and carbon black having an average particle size of 0.04 μm, a specific surface area of 40 m²/g and polytetrafluoroethylene at a mixing ratio of 8:1:1 was prepared. The mixture was rolled to make a sheet 33 of non-faradic reaction layer. The non-faradic reaction sheet 33 and a positive electrode collector were bonded by spraying. The coin type energy storage device was prepared in accordance with the manner of embodiment 3, except that the above positive electrode plate was used.

### Embodiment 10

A coin type energy storage device having a structure shown in FIG. 3 was prepared.

A positive electrode plate 41 having a positive electrode active material layer 43 made of the carbonaceous composite material of embodiment that was coated on the positive electrode collector 42 was prepared in the following manner. The positive electrode active material consisting of carbonaceous material of embodiment 1 and carbon black having an average particle size of 0.04 μm and a specific surface area of 40 m²/g were thoroughly mixed at a mixing ratio of 95:5. A binder solution was an N-methyl pyrrolidone containing 8% by weight of polyvinylidene fluoride. The above carbonaceous material, including carbon black and the binder were thoroughly mixed at a mixing ration of 90:10. The resulting slurry was coated on one face of a positive electrode collector and dried. The coated member was role-pressed with rolls to obtain an electrode material. The electrode material was punched into a disc of an electrode having a diameter of 16 grams.

A coin type energy storage device was prepared in accordance with the manner as in embodiment 3, except that the above positive electrode was used.

### Embodiment 11

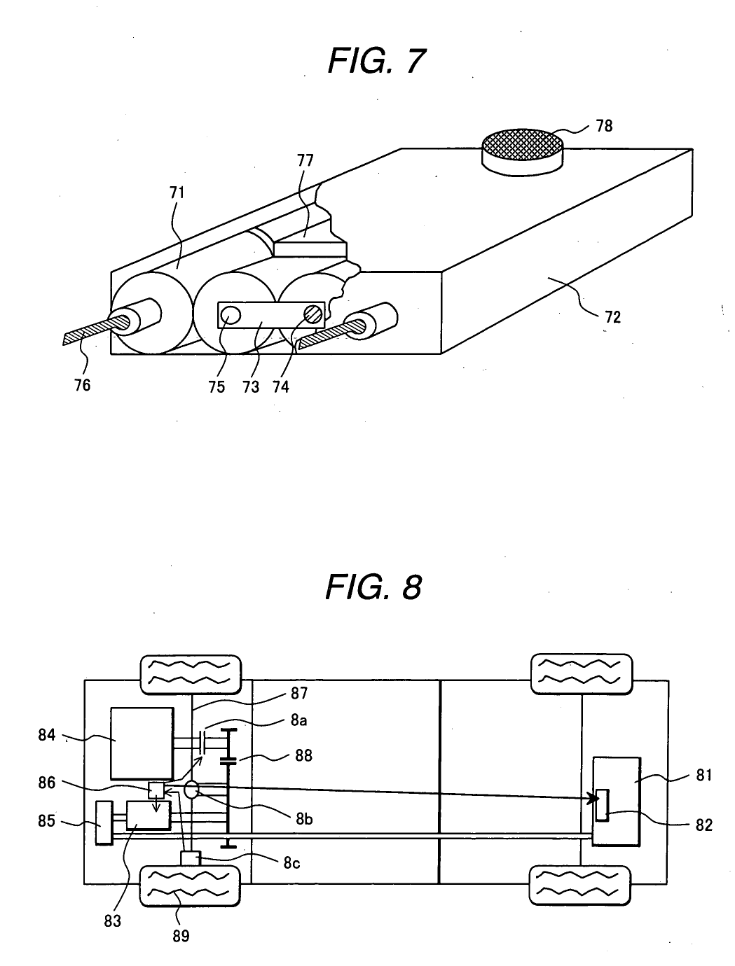

An energy storage module having a structure shown in FIG. 7 was assembled by a plurality of the energy storage devices according to the present invention. 24 Of energy storage devices 71 were connected in series and they were encased in a resin casing 72. Rectangular copper plates 73 having a thickness of 2 mm were used to connect between the energy storage devices 71. The copper plates 73 were fixed to the positive electrode 74 and the negative electrode of the energy storage devices 71 by screwing.

Charge-discharge current was supplied through a cable 76. Each of the energy storage devices 71 was connected through cables 76 thereby to monitor voltages and temperatures of the energy storage devices during charge-discharge. The module is provided with a opening 78 for cooling.

### Embodiment 12

A hybrid car was assembled using two modules of the present invention. In FIG. 8, 81 denotes an energy storage device module, 82 a module control circuit, 83 a motor for driving, 84 en internal engine, 85 an inverter, 86 a power control circuit, 87 a driving shaft, 88 a differential gear, 89 a driving wheel, 8a a clutch, 8b a gear, 8c a car speed monitor. At the time of start of the car, power of the energy storage module 81 is inverted into alternative current. Then, power is input into the motor 83 for driving the car to drive it. The driving motor 83 drives the driving wheel 89 to rotate it thereby to drive the car.

In response to signals from the power source control circuit 86, the module control circuit 82 supplies power from the energy storage device module 81 to the driving motor 83. When the running speed exceeds 20 km/h during the running by the driving motor, the power control circuit 86 sends signals thereby to connect the clutch 8a so that the engine 84 is clutched by a rotation energy from the driving wheel 89.

The power control circuit 86 judges the degree of stepping of an axel in response to signals from the car speed monitor 8c to adjust power supply to the driving motor 83 thereby to control the revolution number of the engine 84.

In deceleration, the driving motor 83 works as a generator to regenerate power to the energy storage device module 81. The hybrid car mounting the energy storage device module of the present invention reduces weight of the module and improves fuel fee.

The energy storage devices or energy storage device modules of the present invention may be applied to various fields. Examples are power sources for portable information terminals such as personal computers, word processors, codeless handsets, electronic books, players, portabletelephones, car telephones, pocket bells, handy terminals, transceivers, wireless radios.

The devices or modules may be used for power sources of portable appliances such as portable coping machines, electronic notebooks, portable calculators, liquid crystal TV sets, portable radios, tape-recorders, headphone stereos, portable CD players, video movies, electric shavers, electronic translators, voice input devices, memory cards, etc.

Further, the devices or modules may be applied to home electric appliances such as refrigerators, air-conditioners, TV sets, stereos, water warmers, microwave ovens, dish-washers, dryers, washing machines, lighting apparatus, toys, etc.

As an industry use or general use, the devices or modules may be applied to medical apparatus, power storage systems, elevators, etc.

Advantages of the devices or modules are remarkable in appliances or systems that need high output-input, such as power sources for mobiles including electric cars, hybrid cars, golf carts, etc.

1. An energy storage device comprising a negative electrode plate having a negative electrode active material layer of a carbonaceous composite material formed on a negative electrode collector, wherein the carbonaceous composite material comprises particles of graphite and/or amorphous carbon and of activated charcoal, the particles of the graphite and/or amorphous carbon and particles of the activated charcoal being united, a positive electrode plate having a positive electrode active material layer capable of inserting and releasing lithium ions and a non-faradic reaction layer capable of accumulating and releasing electric charges upon physical adsorption-desorption of ions on the surface layer of the positive electrode active material layer and an insulator layer for electrically insulating the positive electrode plate from the negative electrode plate and for permeating mobile ions.

2. An energy storage device comprising a negative electrode plate having a negative electrode active material layer of a carbonaceous material formed on a negative electrode collector, wherein at least part of the surface of graphite and/or amorphous carbon is covered with activated charcoal, a positive electrode plate having a positive electrode active material layer formed on positive electrode collector and a non-faradic reaction layer formed on the positive electrode active material, wherein the positive electrode active material layer is a positive electrode active material capable of inserting and releasing mainly lithium upon adsorption-desorption of ions on the positive electrode active material layer, and an insulator layer for electrically insulating the negative electrode plate from the positive electrode plate and for permeating mobile ions.

3. The energy storage device according to claim 1, wherein the non-faradic reaction layer is made mainly of activated charcoal.

4. The energy storage device according to claim 1, wherein the positive electrode active material is at least one member selected from LiNiₓMn_{y}Co_{z}O₂ (x+y+z=1) and composite oxides of transition metals.

5. The energy storage device according to claim 1, wherein a gel like electrolyte substance containing a polymer and a liquid electrolyte is disposed between the positive electrode plate and the negative electrode plate.

6. The energy storage device according to claim 1, wherein in addition to a Li salt or Li compound as a source of the mobile ions, the electrolyte contains a quaternary onium salt represented by the following general formula: 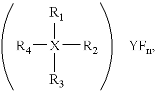
wherein R₁, R₂, R₃ and R₄ are the same or different selected from H and alkyl groups having carbon atoms of 1 to 3, X is N or P, Y is B, P or As, and n is an integer of 4 or 6.

7. An energy storage device module comprising a plurality of the energy storage devices defined in claim 1, wherein the energy storage devices are connected in series, parallel or parallel-series, and a control circuit for controlling each of the energy storage devices.

8. An electric car having a driving motor driven by electric power supplied from the energy storage device module defined in claim 7.

9. A hybrid type electric car having a driving motor and an internal combustion engine, wherein the driving motor is driven by electric power supplied from the energy storage device module defined in claim 7.

10. An energy storage device comprising a negative electrode plate having a negative electrode active material layer of a carbonaceous composite material formed on a negative electrode collector, wherein the carbonaceous composite material comprises particles of graphite and/or amorphous carbon and activated charcoal, the particles of the graphite and/or amorphous carbon and particles of the activated charcoal being united, a positive electrode plate having a positive electrode active material layer capable of inserting and releasing ions and a non-faradic reaction layer, formed on a positive electrode collector, capable of accumulating and releasing electric charges upon physical adsorption-desorption of ions on the surface of the positive electrode active material layer and an insulator layer for electrically insulating the positive electrode plate from the negative electrode plate and for permeating mobile ions.

11. An energy storage device comprising a negative electrode plate having a negative electrode active material layer formed on a negative electrode collector, wherein the negative electrode active material is a carbonaceous material comprising graphite and/or amorphous carbon particles and activated charcoal particles, at lest part of the particles of graphite and/or amorphous carbon being covered with the particles of activated charcoal, a positive electrode plate having a non-faradic reaction layer formed on a positive electrode collector for accumulating and releasing electric charges upon physical adsorption-desorption of ions on the surface of the positive electrode active material layer, and an insulator layer for electrically insulating the positive electrode plate from the negative electrode plate and for permeating mobile ions.

12. The energy storage device according to claim 11, wherein the non-faradic reaction layer is made mainly of activated charcoal.

13. The energy storage device according to claim 11, wherein a gel like electrolyte substance containing polymer and liquid electrolyte is disposed between the positive electrode plate and the negative electrode plate.

14. The energy storage device according to claim 12, wherein in addition to a Li salt or Li compound as a source of the mobile ions, the electrolyte contains a quaternary onium salt represented by the following general formula: 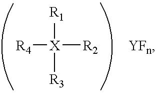
wherein R1, R2, R3 and R4 are the same or different and H or an alkyl group having carbon atoms of 1 to 3, X is N or P, Y is B, P or AS, and n is an integer of 4 or 6.

15. An energy storage device module comprising a plurality of the energy storage devices defined in claim 11, wherein the energy storage devices are connected in series, parallel or parallel-series, and a control circuit for controlling each of the energy storage devices.

16. An electric car having a driving motor driven by the energy storage device module defined by claim 15.

17. An energy storage device comprising a positive electrode plate having a positive electrode active material layer formed on a positive electrode collector, wherein positive electrode active material is a carbonaceous material comprising graphite and/or amorphous carbon particles and activated charcoal particles, the both particles being united, a negative electrode plate having a negative electrode active material layer, wherein the negative electrode active material layer is a carbonaceous material of graphite and/or amorphous carbon particles and activated charcoal particles, the both particles being united, and an insulator layer for electrically insulating the positive electrode plate from the negative electrode plate and for permeating mobile ions.

18. An energy storage device comprising a positive electrode plate having a positive electrode active material layer formed on a positive electrode collector, wherein the positive electrode active material layer is a positive electrode active material comprising graphite and/or amorphous carbon particles and activated charcoal particles, at least part of the particles of the graphite and/or amorphous carbon being covered with the particles of the activated charcoal, a negative electrode plate having a negative electrode active material layer formed on a negative electrode collector, wherein the negative electrode active material layer is a negative electrode active material comprising graphite and/or amorphous carbon particles and activated charcoal particles, at least part of the particles of the graphite and/or amorphous carbon being covered with the activated charcoal, and a insulator layer for electrically insulating the positive electrode plate from the negative electrode plate and for permeating mobile ions.

19. The energy storage device according to claim 12, wherein a gel like electrolyte substance containing polymer and liquid electrolyte is disposed between the positive electrode plate and the negative electrode plate.

20. The energy storage device according to claim 18, wherein in addition to a Li salt or Li compound as a source of the mobile ions, the electrolyte contains a quaternary onium salt represented by the following general formula: 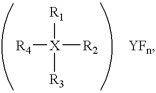
wherein R₁, R₂, R₃ and R₄ are the same or different selected from H and alkyl groups having carbon atoms of 1 to 3, X is N or P, Y is B, P or AS, and n is an integer of 4 or 6.

21. An energy storage device module comprising a plurality of the energy storage devices defined in claim 12, wherein the energy storage devices are connected in series, parallel or parallel-series, and a control circuit for controlling each of the energy storage devices.

22. An electric car having a driving motor driven by the energy storage device module defined by claim 12.

23. A hybrid type electric car having a driving motor and an internal combustion engine, wherein the driving motor is driven by power supplied from the energy storage device module as defined in claim 12.
